(19) United States
(12) Patent Application Publication
(10) Pub. No.: US 2018/0048562 A1
(43) Pub. Date: Feb. 15, 2018

(54) Network Processor Inter-Device Packet Source ID Tagging for Domain Security

(71) Applicant: KnuEdge Incorporated, San Diego, CA (US)

(72) Inventor: Douglas B. Meyer, San Diego, CA (US)

(21) Appl. No.: 15/232,629

(22) Filed: Aug. 9, 2016

(51) Int. Cl. H04L 12/715; H04L 12/26; H04L 29/12; H04L 29/06; H04L 12/933

(52) U.S. Cl. CPC H04L 45/46; H04L 69/22; H04L 49/109; H04L 61/6022; H04L 43/028

(57) ABSTRACT

Systems and techniques for routing and application domain security are described. A described technique includes receiving, at an internal ingress port of a router of a first chip, a first processing packet that includes a first destination identifier from a computing resource of the first chip; obtaining a first source identifier from the first chip's secured register; and routing the first processing packet to a first egress port of the router based on a determination that the first source identifier and the first destination identifier are a first authorized communication pair. The technique can include receiving, at the router's external ingress port, a transport packet, that includes a second source identifier and a second processing packet, from a second chip coupled with the first chip; and performing an authorization process based on the second source identifier and a second destination identifier before routing the second processing packet.

### FIELD OF THE DISCLOSURE

The systems, methods, and apparatuses described herein relate to routing packets within a computing system that has a plurality of computing resources, where communications among the computing resources are carried out based on a network on a chip architecture.

### BACKGROUND

A computing system can include multiple computing resources, at least some of which communicate with each other based on a network on a chip architecture. The computing resources include processing elements, memories, and the like. Processing elements can be referred to as engines or processing cores. Data processed by a processing element can be stored by the processing element, in part remotely, in a memory of the computing system, and, in part locally, in memory registers of the processing element. Often, the processing element combines the items of processed data stored in the memory with the items of processed data stored in the memory registers and then sends the combined processed data items to another processing element for further processing (e.g., as part of a software pipeline).

This is conventionally accomplished by the processing element by performing the following sequence of operations: a first portion of the processed data to be sent to the other processing element is first retrieved from the memory and then placed into memory registers contiguous with the memory registers already holding a second portion of the processed data to be sent to the other processing element. Upon placement of the retrieved first portion of the processed data in the contiguous registers, the processing element transmits the combined processed data to the other processing element for further processing.

Moreover a system's computing resources can be grouped onto different devices such as different integrated circuits (ICs), or for brevity, chips. Such chips, for example, can include multiple processing cores that communicate using an on-chip communications subsystem that routes packets to and from processing cores on the same chip or on other chips. This on-chip communications subsystem is commonly referred to as a network on a chip (NOC). An integrated circuit having a NOC communications subsystem can be referred to as a NOC processing device, or for brevity, a NOC device. Multiple NOC devices can be integrated into a single system so that all components of the multiple NOC devices are addressable using the same communications subsystem. Typically, the components of the system are all assigned addresses from a single address space. A system of multiple NOC devices that are integrated using a single, addressable communications subsystem can be referred to as a network on a chip complex (NOC complex).

Each chip in a NOC complex has one or more routers that route packets received from processing cores on the same chip or from different chips. A packet received by a chip's router can be routed to a processing core on the same chip from which it originated or to a different chip. In such systems, reads and writes are handled by routing packets to packet-addressable memory blocks on chips in the complex. To write to a particular location in a particular packet-addressable memory block, a processing core can transmit a write packet that causes a particular value to be written to a particular address of the memory block. The write packet contains a write opcode, a value, and an address. To read from a particular location in a particular packet-addressable memory block, a processing core can transmit a read packet that requests that a particular value stored at a particular address of the memory block be written to a particular address of another memory block (i.e., by emitting a subsequent write packet). Thus, a read packet typically has a payload that includes a write packet or information required to generate a write packet.

### SUMMARY

Systems and techniques for application domain based security in a system having multiple processing devices that execute multiple applications are disclosed. In one aspect of the disclosed technologies, a technique can be implemented by a first chip, the first chip including a router, a plurality of computing resources, and a secured register, the first chip being in communication with a second chip. The technique can include receiving, at an internal ingress port of the router, a first processing packet from a computing resource of the plurality of computing resources, and the first processing packet including a first destination identifier; obtaining a first source identifier from the secured register; determining that the first source identifier and the first destination identifier are a first authorized communication pair; and routing the first processing packet to a first egress port of the router based on the first destination identifier. The technique can further include receiving, at an external ingress port of the router, a transport packet from the second chip, the transport packet including a second source identifier and a second processing packet, the second processing packet including a second destination identifier; determining that the second source identifier and the second destination identifier are a second authorized communication pair; and routing the second processing packet to a second egress port of the router based on the second destination identifier.

These and other implementations can include one or more of the following features. Implementations can include determining that the first processing packet is to be routed to a third chip; generating an outgoing transport packet that can include an outgoing transport header and the first processing packet; and causing the first egress port to transmit the outgoing transport packet to the third chip. Generating the outgoing transport packet can include inserting the first source identifier into the outgoing transport header. Implementations can include determining that the second processing packet is to be routed to a third chip; and generating an outgoing transport packet that includes an outgoing transport header and the second processing packet; and causing the second egress port to transmit the outgoing transport packet to the third chip. Generating the outgoing transport packet can include inserting the second source identifier into the outgoing transport header.

Implementations can include determining that the internal ingress port is a valid port of arrival for the first source identifier. Routing the first processing packet can be conditioned on the determination that the internal ingress port is the valid port of arrival for the first source identifier and the determination that the first source identifier and the first destination identifier are the first authorized communication pair. Implementations can include determining that the external ingress port is a valid port of arrival for the second source identifier. Routing the second processing packet can be conditioned on the determination that the external ingress port is the valid port of arrival for the second source identifier and the determination that the second source identifier and the second destination identifier are the second authorized communication pair.

Implementations can include determining a destination application domain identifier associated with the second destination identifier; the second source identifier can include a source application domain identifier; and determining that the second source identifier and the second destination identifier are the second authorized communication pair can include determining that the source application domain identifier matches the destination application domain identifier. In some implementations, the first source identifier can include a cluster identifier that identifies a source cluster of the first chip, the source cluster including the computing resource, and determining that the first source identifier and the first destination identifier are the first authorized communication pair can include using the cluster identifier.

In some implementations, the second source identifier can include a cluster identifier that identifies a source cluster of one or more computing resources on the second chip, and determining that the second source identifier and the second destination identifier are the second authorized communication pair can include using the cluster identifier. In some implementations, the first source identifier can include a first chip number assigned to the first chip. In some implementations, the second source identifier can include a second chip number assigned to the second chip.

In another aspect of the disclosed technologies, a system can include multiple chips include a first chip and a second chip. The first chip can include a first router, a plurality of first computing resources, and a first secured register. A first computing resource of the plurality of first computing resources can be configured to generate a first processing packet, and the first processing packet can include a first destination identifier. The second chip can be coupled with the first chip. The second chip can include a second router, a plurality of second computing resources, and a second secured register. The second chip can be configured to transmit a transport packet to the first chip, the transport packet including a second source identifier and a second processing packet, the second processing packet including a second destination identifier. The first router can be configured to perform operations including receiving, at an internal ingress port of the first router, the first processing packet, obtaining a first source identifier from the secured register, determining that the first source identifier and the first destination identifier are a first authorized communication pair, and routing, after determining that the first source identifier and the first destination identifier are the first authorized communication pair, the first processing packet to a first egress port of the first router based on the first destination identifier. The first router can be configured to perform operations including receiving, at an external ingress port of the first router, the transport packet from the second chip, determining that the second source identifier and the second destination identifier are a second authorized communication pair; and routing, after determining that the second source identifier and the second destination identifier are the second authorized communication pair, the second processing packet to a second egress port of the first router based on the second destination identifier.

These and other implementations can include one or more of the following features. Implementations can include a third chip and a first controller coupled with the first egress port. The first router can be configured to determine that the first processing packet is to be routed to the third chip via the first egress port. The first controller can be configured to generate an outgoing transport packet that includes an outgoing transport header and the first processing packet; insert the first source identifier into the outgoing transport header; and cause a transmission of the outgoing transport packet to the third chip. Implementations can include a third chip and a second controller coupled with the second egress port. The first router can be configured to determine that the second processing packet is to be routed to the third chip via the second egress port. The second controller can be configured to generate an outgoing transport packet that includes an outgoing transport header and the second processing packet; insert the second source identifier into the outgoing transport header; and cause a transmission of the outgoing transport packet to the third chip.

In some implementations, the first router can be configured to perform operations including determining that the internal ingress port is a valid port of arrival for the first source identifier. Routing the first processing packet can be conditioned on the determination that the internal ingress port is the valid port of arrival for the first source identifier and the determination that the first source identifier and the first destination identifier are the first authorized communication pair. In some implementations, the first router can be configured to perform operations including determining that the external ingress port is a valid port of arrival for the second source identifier. Routing the second processing packet can be conditioned on the determination that the external ingress port is the valid port of arrival for the second source identifier and the determination that the second source identifier and the second destination identifier are the second authorized communication pair.

In some implementations, the first source identifier includes a first chip number assigned to the first chip. In some implementations, the second source identifier includes a second chip number assigned to the second chip. In some implementations, the first router is configured to perform operations including determining a destination application domain identifier associated with the second destination identifier. The second source identifier can include a source application domain identifier. Determining that the second source identifier and the second destination identifier are the second authorized communication pair can include determining that the source application domain identifier matches the destination application domain identifier.

In some implementations, the first source identifier includes a cluster identifier that identifies a source cluster of the first chip, where the source cluster includes the computing resource. Determining that the first source identifier and the first destination identifier are the first authorized communication pair can include using the cluster identifier. In some implementations, the second source identifier includes a cluster identifier that identifies a source cluster of one or more computing resources on the second chip. Determining that the second source identifier and the second destination identifier are the second authorized communication pair can include using the cluster identifier. In some implementations, the outgoing transport header is an outgoing medium access control (MAC) header; the outgoing MAC header can include a MAC source address, where the MAC source address is separate from the first source identifier included in the outgoing transport header.

Particular aspects of the disclosed technologies can be implemented so as to realize one or more of the following potential advantages. A system executing multiple applications can use trusted source identifier tagging to increase application domain security. Packet filtering based on trusted source identifiers can minimize or eliminate snooping and corruption among devices executing in different application domains. Packet filtering based on trusted source identifiers can minimize or eliminate malicious activity between application domains. Changing a pre-existing processing packet format is not required to implement packet tagging with trusted source identifiers. Identification of unauthorized packets can be performed in low-level hardware without software or firmware intervention, and thus applications themselves have no access to the configuration information. Trusted source identifiers can be used to filter a spoofed destination identifier, or a destination identifier that acquires one or more bit errors during transit.

Details of one or more implementations of the disclosed technologies are set forth in the accompanying drawings and the description below. Other features, aspects, descriptions and potential advantages will become apparent from the description, the drawings, and the claims.

### BRIEF DESCRIPTION OF THE DRAWINGS

FIG. 1 shows a diagram of an example of a computing system that includes an on-chip router configured to perform packet source filtering and trusted source tagging.

FIG. 2 shows an architecture of an example of a network on a chip router including details of a chip of a computing system.

FIG. 3 shows an example of an inter-chip routing architecture including router ports that are used for routing packets between two different chips.

FIGS. 4A and 4B show architectures of examples of an on-chip router for filtering, tagging, and routing between different types of ingress ports and an external egress port.

FIG. 5 shows a diagram of an example of a topology of a computing system.

FIG. 6 shows a format of an example of a processing packet.

FIG. 7 shows a format of an example of a transport packet that encapsulates a processing packet.

FIG. 8 shows a flow diagram of an example of an inter-chip routing process performed by an on-chip router.

### DETAILED DESCRIPTION

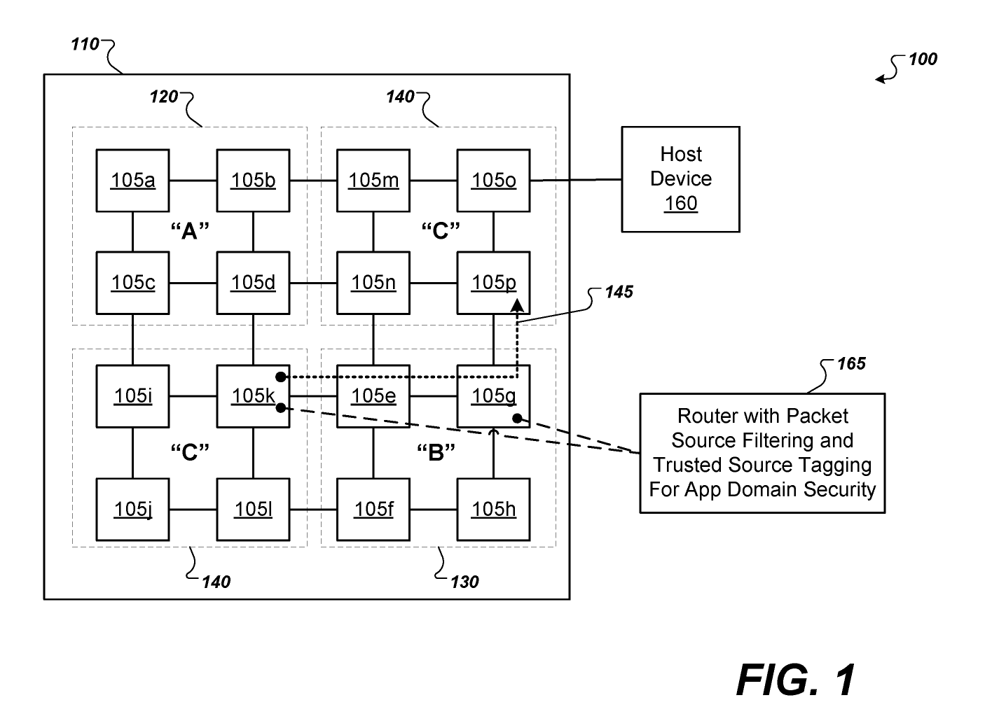

FIG. 1 shows a diagram of an example of a computing system 100 that includes an on-chip router 165 configured to perform packet source filtering and trusted source tagging. The computing system 100 includes a host device 160 in communication with a NOC complex 110, or for brevity, a complex 110. The host device 160 is any appropriate computing device that can provide for interaction with the complex 110. For example, the host device 160 can be a server, blade, laptop, desktop computer, smart phone, tablet computer, or any other appropriate device that includes one or more processors, computer readable media, and input and output devices for interaction with the complex 110. The complex 110 includes chips 105a-p that are coupled together with external wiring for inter-chip communications and communications with host device 160. The chips 105a-p can include computing resources such as cores that are coupled together via an on-chip network and one or more on-chip routers such as router 165. Note that the chip 105k, for example, can directly communicate packets to the chip 105i since these chips are directly coupled together, however the chip 105k can only send packets to the chip 105p by routing packets through one or more other chips such as the chips 105e, 105g.

The host device 160 can configure the complex 110 to run multiple applications. Each application has a respective application domain. An application domain can define a mapping of one or more system components such as chips 105a-p in the complex 110 to particular applications. Typically, each application domain is mapped to multiple components, but each component that is assigned to an application domain is mapped to exactly one application domain at a time. In the example of FIG. 1, the host device 160 creates an application domain A 120 for application “A” and assigns chips 105a-d to application domain A 120. Further, the host device 160 creates an application domain B 130 for application “B” and assigns chips 105e-h to application domain B 130. Further still, the host device 160 creates an application domain C 140 for application “C” and assigns chips 105i-p to application domain C 140. In some implementations, the host device 160 dynamically assigns chips 105a-p to application domains and those assignments can change as applications start and complete.

While the host device 160 can be configured to assign chips 105a-p in a contiguous fashion, it may not always be possible. In this example, the host device 160 created two disjoint chip groups for application domain C 140. Thus, a packet 145 between these disjoint chip groups of application domain C 140 may have to flow through chips assigned to a different application domain. For example, the chip 105k sends a packet 145 for chip 105p, both of application domain C 140, via chips 105e, 105g of application domain B 130.

Each chip 105a-p can include a chip router 165 that is configured to perform, in addition to packet routing, packet source filtering and trusted source tagging for application domain security. Since a packet 145 can carry read, write, or other instructions which may change the system state, memory can be altered or read by such a packet 145. Thus, the system 110 can create a security policy for its application domains 120, 130, 140 such that an application having a particular application domain is assured that it will not suffer from interactions with other applications that belong to other application domains. For example, a packet 145 belonging to application domain C 140 cannot read from or write to destinations belonging to a different domain, e.g., application domain A 120 or application domain B 130. Thus, the security policy can ensure that packets interact within their respective domains even if a packet as to be routed across one or more different domains.

To implement an application domain security policy, the router 165 of a chip 105k that originates a packet 145 can tag the packet 145 with a trusted source identifier to identify an origin, e.g., an identifier corresponding to chip 105k. The trusted source identifier is “trusted” in the sense that select applications, such as non-privileged and/or non-system level applications, cannot modify the trusted source identifier, but rather trusted components such as the router 165 are responsible for inserting the trusted source identifier. In some implementations, a medium access control (MAC) controller can insert the trusted source identifier into a transport packet that contains the packet 145. For example, the MAC controller can encapsulate the packet 145 and add a MAC header to form a MAC transport packet.

To safeguard against malicious or corrupted packets causing an unwanted state change or an unauthorized access after the packet 145 leaves chip 105k, a router 165 of another chip 105g, along the packet's 145 path, can determine whether the chip 105k corresponding to the packet's trusted source identifier is authorized to communicate with a destination indicated by the packet 145. In some implementations, an authorization process includes determining whether the source chip 105k and the destination chip 105p belong to the same application domain. In some implementations, an authorization process includes determining whether a packet is permitted to arrive at a specific ingress port.

In some implementations, the computing system 100 can assign application domains at finer levels of granularity. For example, each chip 105a-p can include multiple computing resources such as processing cores that are divided into two or more processing clusters. In some implementations, the host device 160 can assign each processing cluster of a chip 105a-p to a particular application domain. In that case, a single chip 105a-p can have multiple application domains, but each processing cluster on the chip 105a-p would belong to a single application domain. Similarly, the system 100 can assign each processing core to a particular application domain. In that case, a single processing cluster can have multiple application domains, but each processing core in a cluster would belong to a single application domain.

The chips 105a-p can include computing resources such as general purpose processors, digital signal processors (DSPs), specialized logic, or a combination thereof. In some implementations, a core of a chip 105a-p can include one or more general purpose processors, digital signal processors (DSPs), specialized logic, or a combination thereof. A core can be coupled with memory resources such as a memory controller and one or more memory structures, e.g., random access memory, cache memory, or non-volatile memory. Examples of other system architectures that include on-chip routers for routing packets are described in commonly-owned U.S. patent application Ser. No. 15/077,772, for “Chained Packet Sequences in a Network on a Chip Architecture,” filed Mar. 22, 2016, and in commonly-owned U.S. patent application Ser. No. 15/143,215, for “Distributed Contiguous Reads in a Network on a Chip Architecture,” filed Apr. 29, 2016, which are both incorporated herein by reference.

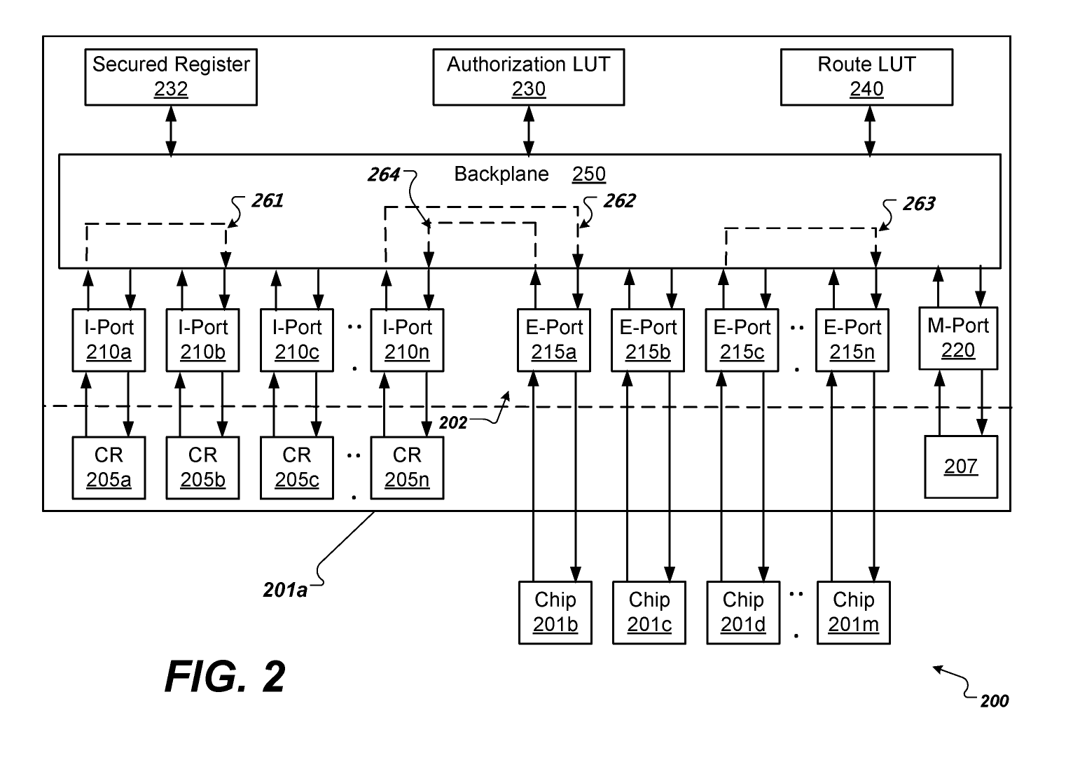

FIG. 2 shows an architecture of an example of a network on a chip router 202 including details of a chip 201a of a computing system 200. The computing system 200 includes interconnected chips 201a-m. The chips 201a-m can be arranged in a topology such as a star, grid, line, or circle. Other types of topologies are possible. While internal details of one chip 201a are shown, such details can also be found in other depicted chips 201b-m whose internal details are not shown due to space constraints. The chip 201a includes a router 202, computing resources 205a-n (labelled CR), and chip management device 207.

The router 202 of chip 201a includes internal ports 210a-n (labelled I-Port), external ports 215a-n (labelled E-Port), management port 220 (labelled M-Port), and a backplane 250. The internal ports 210a-n are coupled with the computing resources 205a-n of the chip 201a. The external ports 215a-n are coupled with other chips 201b-m. The management port 220 is coupled with the chip management device 207. The internal ports 210a-n are coupled with the backplane 250. The external ports 215a-n are coupled with the backplane 250. Further, the management port 220 is coupled with the backplane 250. In some implementations, the backplane 250 includes a switching fabric such as a crossbar or a network of multiplexers. In some implementations, one or more intermediate routers separate the computing resources 205a-n from the router 202, which would be called a top-level router when such intermediate routers are present.

The chip's router 202 can be configured to route packets within the chip 201a and among the other chips 201a-m. For example, the router 202 can forward packets completely within the chip 201a (e.g., see arrow 261). Further, the router 202 can forward packets from an internal source, e.g., computing resource 205n, to an external destination 201b (see, e.g., arrow 262). The router 202 can forward packets from an external source, e.g., chip 201b, to an internal destination, e.g., computing resource 205n (see, e.g., arrow 264). In some implementations, the router 202 can forward packets from one chip 201d to another chip 201m (e.g., see arrow 263).

Associated with an internal network of the chip 201a, the internal ports 210a-n of the router 202 can forward packets to and from the computing resources 205a-n of the chip 201a. Each of the internal ports 210a-n can include an internal ingress port for receiving packets from a respective computing resources 205a-n within the chip 201a. Each of the internal ports 210a-n can include an internal egress port for sending packets to a respective computing resources 205a-n within the chip 201a. In some implementations, an internal port's 210a-n internal ingress port and internal egress port receive and send data over different physical connections. In some implementations, an internal port's 210a-n internal ingress port and internal egress port receive and send data over the same physical connection.

Associated with an external network, the external ports 215a-n of the router 202 can forward packets to and from the other chips 201b-m. Each of the external ports 215a-n can include an external ingress port for receiving packets from another chip 201b-m. Each of the external ports 215a-n can include an external egress port for sending packets to a respective chip 201b-m. In some implementations, an external port's 215a-n external ingress port and external egress port receive and send data over different physical connections. In some implementations, an external port's 215a-n external ingress port and external egress port receive and send data over the same physical connection.

Router ports such as internal ports 210a-n, external ports 215a-n, and management ingress port 220 can look up a route using a route look-up table (LUT) 240. For example, an internal port 210a-n can send a look-up request containing a received packet's destination identifier to the route LUT 240, and the route LUT 240 can respond with an egress port identifier corresponding to one of the ports 210a-n, 210a-n, 220. The internal port 210a-n can route, e.g., forward, the received packet to a port corresponding to the egress identifier. In some implementations, the route LUT 240 is included in a router controller. In some implementations, the router 202 includes two or more route LUT 240 to reduce contention. In some implementations, each port 210a-n, 215a-n includes its own route LUT.

For packets internally generated by the chip 201a, a secured register on the chip 201a can be used to determine a trusted source identifier for a packet authorization process. The secured register 232 is “secured” in the sense that it may only be configured by a secure root of trust and select applications, such as non-privileged and/or non-system level applications, executing on the computing resources 205a-n are not able to modify the contents of the secured register 232. In some implementations, the contents of the secured register 232 can be configured during a secured boot process by a host device. In some implementations, each internal port 210a-n includes its own secured register.

In some implementations, each computing resource 205a-n on the chip 201a executes within the same application domain. Thus, in some implementations, the secured register 232 contains device identifier (DEVID), such as a chip identifier, corresponding to the chip 201a that is used for a trusted source identifier since there is a one-to-one mapping between chip and application domain. Further, in some implementations, a device identifier stored in the secured register 232 can be used to determine whether an incoming packet has arrived at the device to which it is addressed. Alternatively, in some implementations, the secured register 232 contains an application domain identifier (AD-ID), corresponding to an application domain assigned to the chip 201a, can be used as a trusted source identifier for internally generated packets. In some implementations, each computing resource 205a-n on the chip 201a executes within a separate, dynamically configurable application domain (e.g., the system 200 can configure each resource 205a-n to be in the same or different application domain during execution), and there is a separate secured register for each computing resource 205a-n.

For internal packets leaving the chip 201a, the router 202 can tag, or cause a MAC controller to tag, such packets with a source identifier retrieved from the secured register 232. Likewise, packets originally sourced at other chips 201b-m can be similarly tagged. For tagged packets received from other chips 201b-m, a trusted source identifier exactor (not shown) within the router 202 can be used to extract a trusted source identifier for a packet authorization process.

Internal ports 210a-n and external ports 215a-n can perform packet authorization. In some implementations, an internal port 210a-n can determine a trusted source identifier by reading from the secured register 232 on the chip 201a for an internal packet, e.g., received from a computing resource 205a-n which is considered an internal source since it is located on the same chip 201a as the router 202. The internal port 210a-n can send an authorization request containing the trusted source identifier and the received internal packet's destination identifier to the authorization LUT 230. Using a look-up table populated with source identifier and destination identifier pairs, the authorization LUT 230 can respond to the request with an authorization status code, e.g., authorized or not authorized. In some implementations, the authorization request can include an ingress port identifier so that the authorization LUT 230 can determine whether the corresponding ingress port is a valid port of arrival for a packet. In some implementations, the authorization LUT 230 is included in a router controller. In some implementations, each port 210a-n, 215a-n includes its own authorization LUT.

The route LUT 240 and the authorization LUT 230 can be configured by a chip management device 207. In some implementations, management device 207 can include one or more chip configuration registers, such as a chip's device identification register, and can be a root of trust or can be under the control of a root of trust for computing system architectures which require a particular level of security. A host device can communicate with the chip management device 207 to configure one or more LUTs such as the route LUT 240, the authorization LUT 230, or both. In order to maintain a level of application domain security, applications running on the chips 201a-m should not be allowed to modify the route LUT 240 or the authorization LUT 230 of the router 202. In some implementations, such LUT configuration is performed by a secured, privileged level process. For example, to configure the route LUT 240 and the authorization LUT 230, secure software running on a host device can communicate with the chip management device 207 on a secure channel to exchange a secure key. Afterwards, the host device can send, to the chip management device 207 of one or more chips, configuration packets containing routing information, authorization information, or both. The chip management device 207 can verify the configuration packets using the secure key and can carry out the instructions in the packets, e.g., by writing information to the route LUT 240, authorization LUT 230, or both. In some implementations, chip management device 207 can be configured as a root of trust and the chip management device 207 can retrieve LUT configuration information from an internal or external secure persistent memory such as an NVRAM or a flash memory device.

Routing information to configure a route LUT can include pairs of destination identifiers and egress port numbers. Authorization information to configure an authorization LUT can include one or more records, each record including a source identifier, destination identifier, and authorization status. For example, a record can indicate whether packet traffic associated with a record's source identifier is allowed to flow to a destination associated with the record's destination identifier. In some implementations, authorization information can include information to map device identifiers to their respectively assigned application domain identifiers, and an authorization process can determine whether a packet's trusted source device identifier and the packet's destination device identifier map to the same application domain.

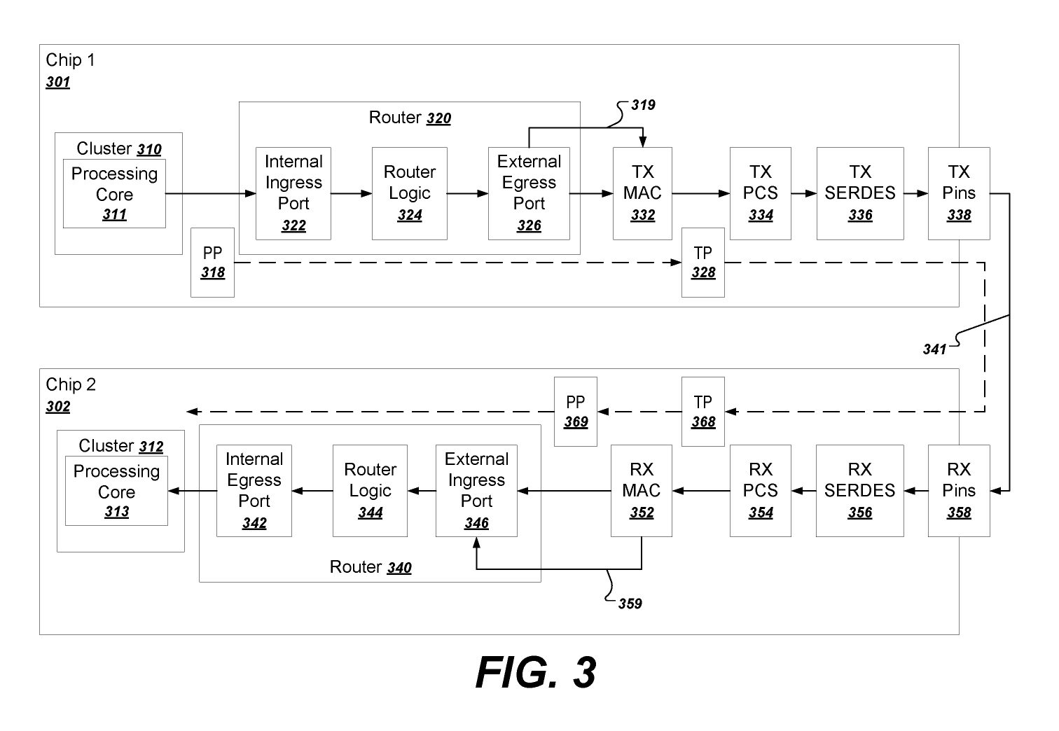

FIG. 3 shows an example of an inter-chip routing architecture including router ports that are used for routing packets between two different chips 301, 302. A first processing core 311 on a first chip 301 sends a packet to a second processing core 313 on a separate, second chip 302. The first processing core 311 of a cluster 310 sends a processing packet (PP) 318 to a router 320 of the first chip 301, optionally via an intermediate router. Because the processing packet 318 originates from within the same chip 301, the processing packet 318 is received by the router 320 at an internal ingress port 322. The router 320 then uses router logic 324 to determine an external egress port 326 of the router 320 out of which the processing packet 318 will be sent. Note that the router 320 can include multiple ingress ports and multiple egress ports, however, only internal ingress port 322 and external egress port 326 are depicted for clarity.

Next, the external egress port 326 outputs the processing packet 318 to a TX media access control (MAC) controller 332 that performs operations of a MAC layer, e.g., framing and adding an error correction code. The TX MAC controller 332 encapsulates the processing packet 318 to form a transport packet 328 containing a transport header and the processing packet 318. Further, external egress port 326 outputs a trusted source identifier 319 associated with the processing packet 318. In some implementations, the trusted source identifier 319 is retrieved from a secured register holding an identifier value such as a numerical identifier assigned to the chip 301. During encapsulating to form the transport packet 328, the TX MAC controller 332 can insert the trusted source identifier 319 into a predetermined portion of the transport header.

After receiving the transport packet 328 from the TX MAC controller 332, a TX physical coding sublayer (PCS) controller 334 can scramble the transport packet 328 to maintain a direct current (DC) balance over a physical connection 341. A TX serializer/deserializer (SERDES) 336 can convert the scrambled packet data into a serial bit stream signal. TX Pins 338 on the first chip 301 are physically connected, via connection 341, to RX pins 358 of the second chip 302. The connection 341 carries the bit stream signal corresponding to the transport packet 328 from the first chip 301 to the second chip 302.

Based on receiving a version of the transport packet 328, the RX SERDES 356 transforms the packet's serial bit stream back into a scrambled data packet, which is descrambled by the RX PCS controller 354. After descrambling, the RX PCS controller 354 outputs a received transport packet 368 corresponding to the original transport packet 328. The RX MAC controller 352 can interpret the data payload in the received transport packet 368 from any framing added by the TX MAC controller 332 and can check the error correction code. If there are no errors, the RX MAC controller 352 can pass the packet payload corresponding to the original processing packet 318 (now processing packet 369) to an external ingress port 346 of a router 340 of the second chip 302. Further, the RX MAC controller 352 can extract a trusted source identifier from a transport header of the received transport packet 368, and provide the trusted source identifier 359 to the external ingress port 346 together with the processing packet 369.

The external ingress port 346 the router 340 can perform ingress source based filtering on the processing packet 369 using the trusted source identifier 359. If the ingress source based filtering allows the processing packet 369 to continue, the router 340 can use router logic 344 to determine an internal egress port 342 out of which the processing packet 369 will be sent. Finally, the processing packet 369 is routed to a processing core 313 in a cluster 312 of the second chip 302, optionally via an intermediate router.

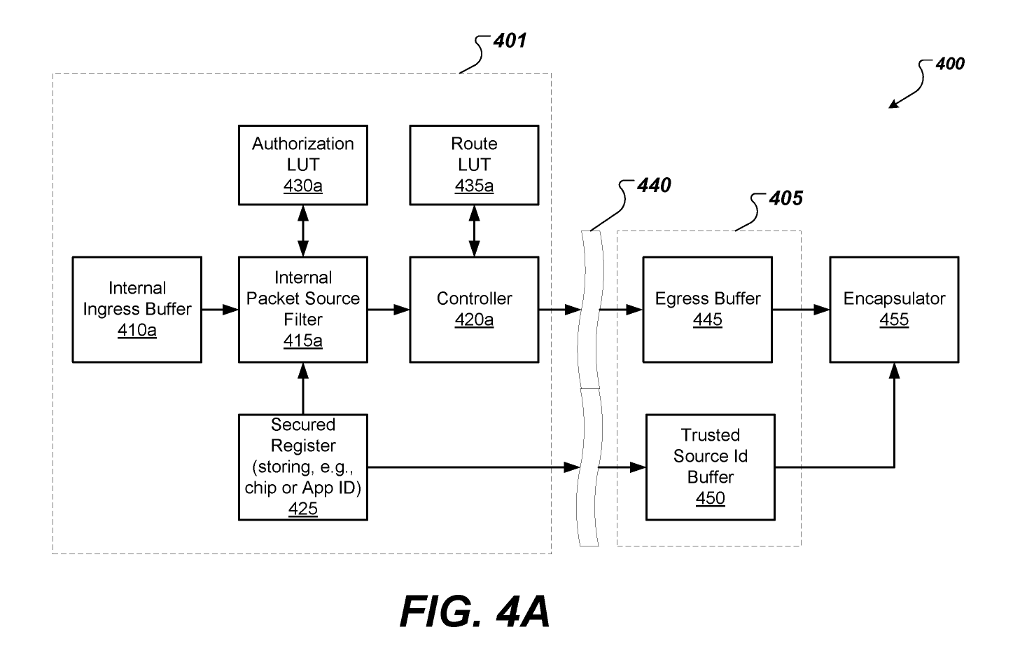

FIGS. 4A and 4B show architectures of examples of an on-chip router for filtering, tagging, and routing between different types of ingress ports 401, 402 and an external egress port 405. FIG. 4A provides details between an internal ingress port 401 and the external egress port 405. FIG. 4B provides details between an external ingress port 402 and the external egress port 405.

FIG. 4A shows a router architecture for filtering, tagging, and routing between an internal ingress port 401 and an external egress port 405 of an on-chip router 400. The internal ingress port 401 includes an internal ingress buffer 410a, internal packet source filter 415a, controller 420a, secured register 425, authorization LUT 430a, and route LUT 435a. In some implementations, a LUT such as the authorization LUT 430a, route LUT 435a, or both is stored in a centralized router location and can be shared among multiple ports. A backplane 440 couples the internal ingress port 401, along with other ports not shown, with egress ports including the external egress port 405. The external egress port 405 includes an egress buffer 445 and a trusted source identifier buffer 450. The external egress port 405 is coupled with an encapsulator 455.

The internal ingress buffer 410a of the internal ingress port 401 can receive packets that originate from one or more internal sources that reside on the same device, e.g., same chip, as the router 400. The internal packet source filter 415a can perform a packet authorization process on a packet stored within the internal ingress buffer 410a. The internal packet source filter 415a can extract a destination identifier from a buffered packet and retrieve a trusted source identifier from the secured register 425 that corresponds to an originating internal source of the buffered packet. Based on this identifier pair, the internal packet source filter 415a can look-up the pair within the authorization LUT 430a to determine whether the pair is an authorized communication pair.

The secured register 425 is “secured” in the sense that it is isolated from applications that generate processing packets, such applications are not able to modify the contents of the secured register 425. In this example, the internal ingress port 401 includes its own secured register 425 which can be securely programmed to identify a packet source injecting packets into the port's 401 internal ingress buffer 410a. In some implementations, internal ingress port 401 is hard-wired to a singular internal source such as a processing core that is included in the same chip as the router 400. In some implementations, internal ingress port 401 is hard-wired to a group of internal sources. In some implementations, one or more intermediate on-chip routers separate the internal ingress port 401 from a group of internal sources. In some implementations, the contents of the secured register 425 includes a device identifier (such as a chip identifier), a processing cluster identifier, core identifier, or a combination thereof. In some implementations, the contents of the secured register 425 includes an application domain identifier.

In some implementations, there is a one-to-one mapping between application domain and chip where each internal source of a chip containing the router 400 executes within the same application domain, and accordingly, the secured register 425 contains a device identifier corresponding to the chip. In some implementations, groups of one or more internal sources within the chip can execute within their own respective application domains, and the secured register 425 contains an identifier, such as a cluster identifier, that identifies a specific group of internal sources. In some implementations, the secured register 425 includes both a cluster identifier and a device identifier.

If authorized by the internal packet source filter 415a, the internal packet source filter 415a passes the buffered packet to the controller 420a. The controller 420a can perform a route look-up using the router LUT 435a to determine the appropriate egress port 405. The controller 420a can forward the buffered packet to the egress port 405 via the backplane 440. Further, the controller 420a can forward the trusted source identifier, retrieved from the secured register 425, to a trusted source identifier buffer 450 of the external egress port 405 via the backplane 440. In some implementations, after receiving a notification, the external egress port 405 retrieves the buffered packet and the trusted source identifier from the internal ingress port 401. In some implementations, the trusted source identifier can be added to a frame including the buffered packet such that the identifier and the buffered packet are transferred via the same communication pathway within the backplane 440. In some implementations, the egress buffer 445 can be merged with the trusted source identifier buffer 450. In some implementations, the trusted source identifier can be signaled as a flag within a frame including the buffered packet. For example, if the flag indicates that the packet originated within a chip, then the flag can cause a component such as the egress port 405 or the encapsulator 455 to retrieve an identifier directly from the secured register 425 for use as the trusted source identifier.

The encapsulator 455 is configured to retrieve a packet from the egress buffer 445 of the external egress port 405. In some implementations, the encapsulator 455 is apart of a MAC controller. The encapsulator 455 includes the retrieved packet into a transport packet and adds a transport header such as a MAC header. The encapsulator 455 is configured to retrieve a trusted source identifier from the trusted source identifier buffer 450 that corresponds to the retrieved packet and inserts the retrieved trusted source identifier into the transport header of the transport packet. The encapsulator 455 can send the transport packet to a physical (PHY) layer unit for transmission.

FIG. 4B shows a router architecture for filtering, tagging, and routing between an external ingress port 402 and an external egress port 405 of the on-chip router 400. The external ingress port 402 includes an ingress buffer 410b, external packet source filter 415b, controller 420b, trusted source identifier extractor 427, authorization LUT 430b, and route LUT 435b. A backplane 440 couples external ingress port 402, along with other ports not shown, with egress ports including external egress port 405.

The external ingress buffer 410b of the external ingress port 402 can receive packets that originate from one or more external sources that reside on a device that is different from the device containing the router 400. The external packet source filter 415b can perform a packet authorization process on a packet stored within the external ingress buffer 410b. The external packet source filter 415b can extract a destination identifier from the buffered packet. The trusted source identifier extractor 427 can extract a trusted source identifier from a transport header corresponding to the buffered packet. Based on this identifier pair (e.g., extracted trusted source identifier and extracted destination identifier), the external packet source filter 415b can look-up the pair within the authorization LUT 430b to determine whether the pair is an authorized communication pair. In some implementations, the contents of the extracted trusted source identifier includes a device identifier (such as a chip identifier), a processing cluster identifier, core identifier, an application domain identifier, or a combination thereof.

If authorized by the external packet source filter 415b, the external packet source filter 415b passes the buffered packet to the controller 420b. The controller 420b can perform a route look-up using the router LUT 435b to determine the appropriate egress port 405. The controller 420b can forward the buffered packet to the egress port 405 via the backplane 440. Further, the controller 420b can forward the extracted trusted source identifier to a trusted source identifier buffer 450 of the external egress port 405 via the backplane 440. In some implementations, after receiving a notification, the external egress port 405 retrieves the buffered packet and the extracted trusted source identifier from the external ingress port 402.

The encapsulator 455 is configured to retrieve a packet from the egress buffer 445 of the external egress port 405. In some implementations, the encapsulator 455 is apart of a MAC controller. The encapsulator 455 includes the retrieved packet into a transport packet and adds a transport header such as a MAC header. The encapsulator 455 is configured to retrieve an extracted trusted source identifier from the trusted source identifier buffer 450 that corresponds to the retrieved packet, and insert the retrieved trusted source identifier into the transport header of the transport packet. The encapsulator 455 can send the transport packet to a PHY layer unit for transmission.

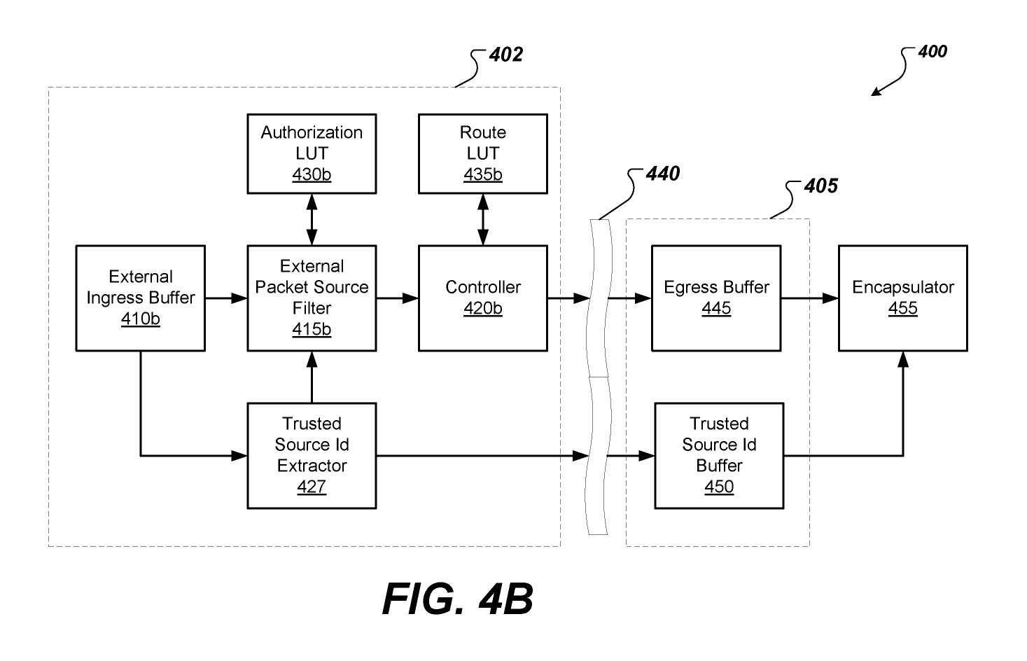

FIG. 5 shows a diagram of an example of a topology of a computing system 501. The computing system 501 includes chips 505a-e arranged in a linear topology. Some chips are configured for domain A (e.g., A1 chip 505a and A2 chip 505c), another chip is configured for domain B (e.g., B1 chip 505b), and other chips are configured for domain C (e.g., C1 chip 505d and C2 chip 505e). In this example, the chips 505a, 505c in Domain A are separated by a chip 505b in Domain B. Packets can travel between chips 505a-e via one or more paths. In this linear topology, each chip 505a-e can include a left-hand set of ingress and egress ports and a right-hand side of ingress and egress ports. An egress port of one chip 505a-e is connected with an ingress port of another chip 505a-e.

Under the depicted topology of the computing system 501, the right-hand side ingress port of the A2 chip 505c should not receive any packets, because nothing on its right-hand side is in Domain A. Further, the right-hand side egress port of the A2 chip 505c, should not send any packets, because nothing to the left of the C1 chip 505d is in Domain C. The left-hand side egress port of the A2 chip 505c may send packets but the packets should all be for Domain A (e.g., to the A1 chip 505a). The left-hand side ingress port of the A2 chip 505c may receive packets but the packets should all be for Domain A (e.g., from the A1 chip 505a).

A malicious process, as an example, running on the A1 chip 505a may try to inject a processing packet into the network with a destination within application domain C. In doing so, the malicious process may attempt to corrupt data within the application domain C or read sensitive data therefrom. An ingress source filtering mechanism on the A1 chip 505a can be configured to determine that the A1 chip 505a is not currently authorized to communicate with any chips 505d-e in the application domain C, and can be configured to drop the malicious processing packet. The ingress source filtering mechanism can use a trusted source identification technique, as described herein, to distinguish between legitimate packets and illegitimate packets.

Alternatively, rather than a malicious process, a data corruption event may occur. In particular, a bit within a processing packet's destination address may become corrupted. A normal process, as an example, running on the A1 chip 505a may send a processing packet into the network with an original destination address within the A2 chip 505c. However, after transmission from the A1 chip 505a, a data corruption event causes the original destination address to become a corrupted destination address corresponding to an address associated with the C2 chip 505e. If left unchecked, a memory operation specified by the corrupted processing packet can cause serious damage to the state of application domain C. Thus, the computing system 501 through an ingress source filtering mechanism on a chip 505b-c intercepting the processing packet after the corruption event can appropriately handle the packet before the packet can harm application domain C.

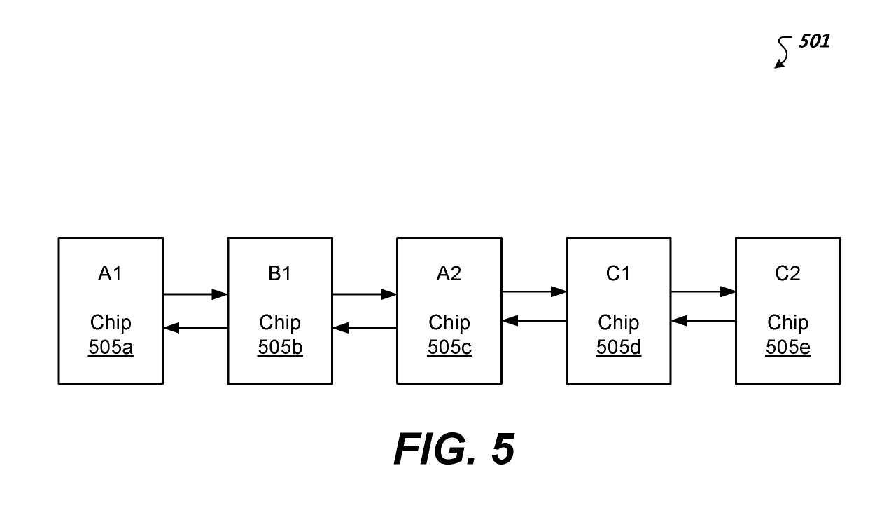

FIG. 6 shows a format of an example of a processing packet 601. The processing packet 601 can include a header 612 and a payload 614. The header 612 can include a packet length field, an packet opcode (POP) field, and a destination address field. To save space and increase bandwidth, the header 612 lacks a source address. The packet 601 can include a payload 614. In some implementations, if a particular packet does not include a payload, the packet length field of the header 612 has a value of zero.

The destination address of the header 612 can include a hardware identifier component such as a device identifier (e.g., DEVID), cluster identifier (e.g., CLSID), core identifier (e.g., COREID), or a combination thereof. Further, the destination address of the header 612 can include a memory address component such as a physical memory address (e.g., PADDR) or a virtual memory address (e.g., VADDR). The POP field of the packet 601 can include a code to indicate an operation to be performed by a destination computing resource identified by the hardware identifier component of the destination address field on a memory address included in the destination address field. Exemplary operations in the POP field can include a read operation and a write operation.

Computing systems can use packets, such as the packet 601 of FIG. 6, to write to a particular location in a particular packet-addressable memory block. A processing core, for example, can transmit a write packet that causes a particular value to be written to a particular address of the memory block. Further, computing systems can use packets, such as the packet 601 of FIG. 6, to read from a particular location in a particular packet-addressable memory block. A processing core, for example, can transmit a read packet that requests that a particular value stored at a particular address of the memory block be written to a particular address of another memory block (i.e., by transmitting a subsequent write packet). Thus, a read packet typically has a payload that includes a write packet or information required to generate a write packet.

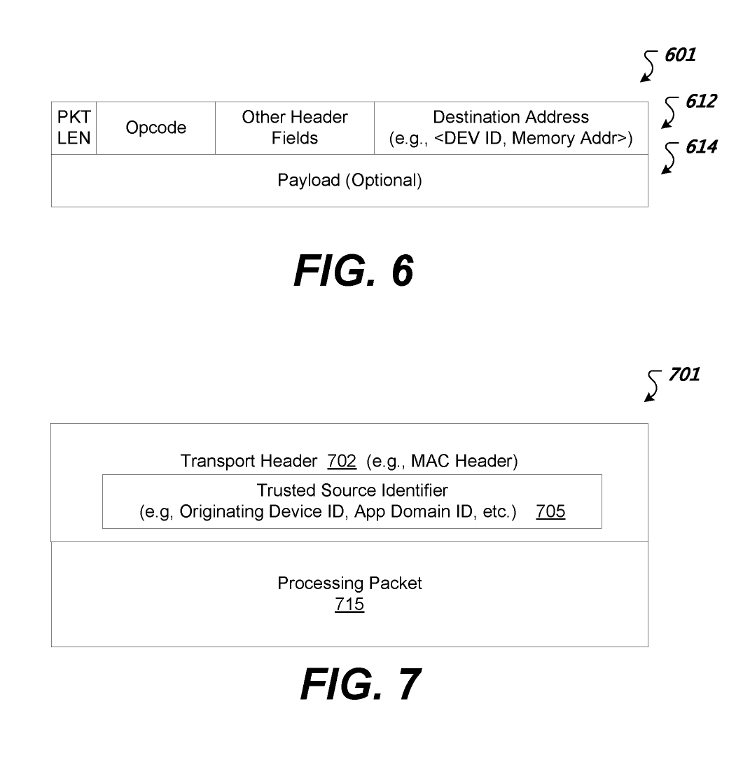

FIG. 7 shows a format of an example of a transport packet 701 that encapsulates a processing packet. The transport packet 701 includes a transport header 702 and a processing packet 715 (e.g., see processing packet 601 of FIG. 6). The transport header 702 includes a trusted source identifier 705 that resides in a predetermined area of the header 702 and identifies an origin of the processing packet 715. The trusted source identifier 705 is considered “trusted” since low-level hardware such as a router or a TX MAX controller inserted the trusted source identifier 705, where such low-level hardware is not compromised by malicious activity. In some implementations, the trusted source identifier 705 includes an originating device identifier (such as an assigned chip number), a processing cluster identifier, core identifier, or a combination thereof. In some implementations, the trusted source identifier 705 includes an application domain identifier.

In some implementations, the transport header 702 includes a MAC source address and a MAC destination address. However, the trusted source identifier 705 is separate from the MAC source address and the MAC destination address. Unlike a typical MAC source address that identifies the most recent device to handle the packet, and therefore changes from hop to hop, the trusted source identifier 705 does not change and therefore is maintained from hop to hop.

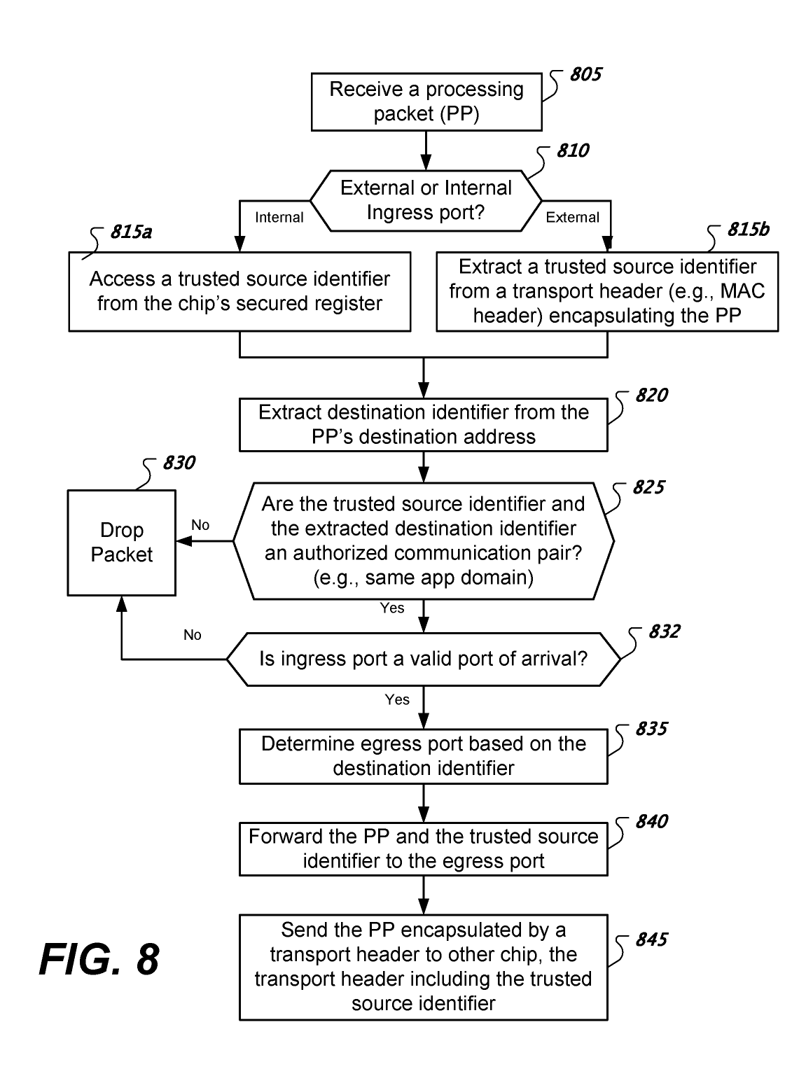

FIG. 8 shows a flow diagram of an example of an inter-chip routing process performed by an on-chip router. At 805, the process receives a processing packet (processing packet). Receiving the processing packet can include receiving the processing packet from a core within the chip via an internal ingress port. Receiving the processing packet can include receiving the processing packet encapsulated by a transport header from another chip via an external ingress port. At 810, the process determines whether the processing packet is received from an internal ingress port or an external ingress port. If internal, then the process, at 815a, accesses a trusted source identifier from the chip's secured register. If external, then the process, at 815b, extracts a trusted source identifier from a transport header (e.g., MAC header) encapsulating the processing packet. At 820, the process extracts a destination identifier from the processing packet's destination address. Extracting a destination identifier can include using a masking and bit shifting technique to extract data from the destination address. In some implementations, the destination address includes a destination identifier such as a device identifier and a memory address.

At 825, the process determines whether the trusted source identifier and the extracted destination identifier are an authorized communication pair. In more detail, the process determines whether a computing resource associated with the trusted source identifier is authorized to communicate with a computing resource associated with the destination identifier. Determining whether the trusted source identifier and the extracted destination identifier are an authorized communication pair can include whether the identifiers are associated with the same application domain. Determining whether the trusted source identifier and the extracted destination identifier are an authorized communication pair can include accessing a look-up table that is indexed by source identifiers and destination identifiers, where each pair of identifiers has an associated value corresponding to how to handle such a packet, e.g., route packet, drop packet, route and log, or reroute to a security process. In some implementations, a source identifier and a destination identifier include respective source and destination chip numbers, and the source and destination chip numbers can be used to access an authorization look-up table indexed by chip number pairs. In some implementations, a source identifier and a destination identifier can be converted into respective source and destination application domain identifiers, and the source and destination application domain identifiers can be used to access an authorization look-up table indexed by application domain identifier pairs. In some implementations, the source identifiers and destination identifiers can include respective source and destination application domain identifiers.

If the identifiers are not an authorized communication pair, then the process, at 830, can drop the processing packet. Note that other handling techniques besides packet dropping are possible, such as logging or routing to a default security processor for further processing. If the trusted source identifier and the extracted destination identifier are an authorized communication pair, then the process, at 832, determines whether the ingress port is a valid port of arrival for the processing packet. Determining whether the ingress port is a valid port of arrival can include accessing a routing policy table to check if the packet's associated source identifier is permitted to arrive at this particular ingress port. If the ingress port is not a valid port, the processing packet can be dropped at 830. Otherwise, at 835, the process determines an egress port based on the destination identifier. Determining the egress port can include accessing a look-up table based on a device identifier of the destination identifier, where the look-up table is configured to return an egress port identifier.

The process, at 840, forwards the processing packet and the trusted source identifier to the egress port. Forwarding data such as the processing packet and the trusted source identifier can include sending a memory pointer corresponding to the processing packet via a backplane to the egress port and causing the egress port to retrieve the data using the memory pointer. The process, at 845, sends the processing packet encapsulated by a transport header to another chip, the transport header including the trusted source identifier. In some implementations, the egress port is coupled with a MAC controller that encapsulates the processing packet within the transport header and inserts the trusted source identifier into the transport header.

A computing system can be configured to execute multiple application domains within different clusters of the same chip. Thus, ingress port filtering can be expanded to the cluster level. For example, a chip router can filter packets by using originating chip information and originating cluster information. Thus, a trusted source identifier used in the filtering process can include a chip identifier and a cluster identifier, where the cluster identifier identifies an originating cluster within a chip corresponding to the chip identifier. For an internal packet leaving a chip, the TX MAC controller can insert the chip's chip identifier and a cluster identifier, corresponding to the originating cluster, into an area of a transport header encapsulating the packet.

One or more routers within a chip can perform cluster level ingress port filtering for a packet originating from a source cluster of the chip and addressed to a destination cluster of the chip. Cluster level ingress port filtering can include determining a source cluster identifier for a received packet and determining whether the source cluster identifier is authorized to communicate with a destination cluster identifier. In some implementations, the destination cluster identifier can be extracted from a device identifier within a destination address of the packet. In some implementations, the source cluster identifier is retrieved from a secured register associated with an ingress port that received the packet, here the ingress port is dedicated to receiving from a specific, single cluster of cores. Since an ingress port can be permanently wired to receive packets from a single cluster, in some implementations, the source cluster identifier is retrieved from a secured register such as a hardwired register that always provides the same value.

A system, in some implementations, can include a first chip comprising a first router, a plurality of first computing resources, and a first secured register to store a first source identifier, the first source identifier representing a chip number assigned to the first chip. The system can include a second chip coupled with the first chip, the second chip comprising a plurality of second computing resources, and a second secured register to store a second source identifier, the second source identifier representing a chip number assigned to the second chip. A first computing resource of the plurality of first computing resources can be configured to generate a first processing packet, and the first processing packet comprising a first destination identifier. A second computing resource of the plurality of second computing resources can be configured to generate a second processing packet, and the second processing packet comprising a second destination identifier, and the second chip can be configured to transmit a transport packet to the first chip, the transport packet comprising the second source identifier and the second processing packet. In some implementations, the first router is configured to receive, at an internal ingress port of the first router, the first processing packet, obtain the first source identifier from the secured register, determine that the first source identifier and the first destination identifier are associated with a same first application domain, and route, after a determination that the first source identifier and the first destination identifier are associated with the same first application domain, the first processing packet to a first egress port of the first router based on the first destination identifier. The first router can be further configured to receive, at an external ingress port of the first router, the transport packet from the second chip, determine that the second source identifier and the second destination identifier are associated with a same second application domain, and route, after a determination that the second source identifier and the second destination identifier are associated with the same second application domain, the second processing packet to a second egress port of the first router based on the second destination identifier.

A system, in some implementations, can include a first chip comprising a first router, a plurality of first computing resources, and a first secured register; and a second chip coupled with the first chip. The first router is configured to receive, at an ingress port of the first router, a processing packet, the processing packet comprising a destination identifier, wherein the processing packet lacks information identifying a source that originated the processing packet. If the processing packet originated within the first chip, the first router is configured to determine a source identifier that corresponds to the source that originated the processing packet by using a first identifier stored in the first secured register as the source identifier, the first identifier representing a chip number assigned to the first chip. If the processing packet originated within the second chip, the first router is configured to extract a second identifier stored in a transport header of a transport packet encapsulating the processing packet, and use the second identifier as the source identifier, the second identifier representing a chip number assigned to the second chip. The first router can be configured to route the processing packet to an egress port of the first router based on a determination that the source identifier and the destination identifier are associated with a same application domain.

In the above description, numerous specific details have been set forth in order to provide a thorough understanding of the disclosed technologies. In other instances, well known structures, interfaces, and processes have not been shown in detail in order to avoid unnecessarily obscuring the disclosed technologies. However, it will be apparent to one of ordinary skill in the art that those specific details disclosed herein need not be used to practice the disclosed technologies and do not represent a limitation on the scope of the disclosed technologies, except as recited in the claims. It is intended that no part of this specification be construed to effect a disavowal of any part of the full scope of the disclosed technologies. Although certain embodiments of the present disclosure have been described, these embodiments likewise are not intended to limit the full scope of the disclosed technologies.

While specific embodiments and applications of the disclosed technologies have been illustrated and described, it is to be understood that the disclosed technologies are not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the disclosed technologies disclosed herein without departing from the spirit and scope of the disclosed technologies. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application--such as by using any combination of hardware processors, e.g., microprocessors, microcontrollers, field programmable gate arrays (FPGAs), application specific integrated circuits (ASICs), and/or System on a Chip (SoC)—but such implementation decisions should not be interpreted as causing a departure from the scope of the disclosed technologies.

The steps of a method or algorithm described in connection with the embodiments disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the disclosed technologies. In other words, unless a specific order of steps or actions is required for proper operation of the embodiment, the order and/or use of specific steps and/or actions may be modified without departing from the scope of the disclosed technologies.

What is claimed is:

1. A method implemented by a first chip, the first chip comprising a router, a plurality of computing resources, and a secured register, the first chip being in communication with a second chip, the method comprising:
receiving, at an internal ingress port of the router, a first processing packet from a computing resource of the plurality of computing resources, and the first processing packet comprising a first destination identifier;
obtaining a first source identifier from the secured register;
determining that the first source identifier and the first destination identifier are a first authorized communication pair;
routing the first processing packet to a first egress port of the router based on the first destination identifier;
receiving, at an external ingress port of the router, a transport packet from the second chip, the transport packet comprising a second source identifier and a second processing packet, the second processing packet comprising a second destination identifier;
determining that the second source identifier and the second destination identifier are a second authorized communication pair; and
routing the second processing packet to a second egress port of the router based on the second destination identifier.

2. The method of claim 1, comprising:
determining that the first processing packet is to be routed to a third chip;
generating an outgoing transport packet that comprises an outgoing transport header and the first processing packet, wherein generating the outgoing transport packet comprises inserting the first source identifier into the outgoing transport header; and
causing the first egress port to transmit the outgoing transport packet to the third chip.

3. The method of claim 1, comprising:
determining that the second processing packet is to be routed to a third chip; and
generating an outgoing transport packet that comprises an outgoing transport header and the second processing packet, wherein generating the outgoing transport packet comprises inserting the second source identifier into the outgoing transport header; and
causing the second egress port to transmit the outgoing transport packet to the third chip.

4. The method of claim 1, comprising:
determining that the internal ingress port is a valid port of arrival for the first source identifier,
wherein routing the first processing packet is conditioned on the determination that the internal ingress port is the valid port of arrival for the first source identifier and the determination that the first source identifier and the first destination identifier are the first authorized communication pair.

5. The method of claim 1, comprising:
determining that the external ingress port is a valid port of arrival for the second source identifier,
wherein routing the second processing packet is conditioned on the determination that the external ingress port is the valid port of arrival for the second source identifier and the determination that the second source identifier and the second destination identifier are the second authorized communication pair.

6. The method of claim 1, wherein the first source identifier comprises a first chip number assigned to the first chip, and wherein the second source identifier comprises a second chip number assigned to the second chip. The method of claim 1, comprising:
determining a destination application domain identifier associated with the second destination identifier,
wherein the second source identifier comprises a source application domain identifier, and
wherein determining that the second source identifier and the second destination identifier are the second authorized communication pair comprises determining that the source application domain identifier matches the destination application domain identifier.

8. The method of claim 1, wherein the first source identifier comprises a cluster identifier that identifies a source cluster of the first chip, the source cluster comprising the computing resource, and wherein determining that the first source identifier and the first destination identifier are the first authorized communication pair comprises using the cluster identifier.

9. The method of claim 1, wherein the second source identifier comprises a cluster identifier that identifies a source cluster of one or more computing resources on the second chip, and wherein determining that the second source identifier and the second destination identifier are the second authorized communication pair comprises using the cluster identifier.

10. A system comprising:
a first chip comprising a first router, a plurality of first computing resources, and a first secured register, wherein a first computing resource of the plurality of first computing resources is configured to generate a first processing packet, and the first processing packet comprising a first destination identifier; and
a second chip coupled with the first chip, wherein the second chip is configured to transmit a transport packet to the first chip, the transport packet comprising a second source identifier and a second processing packet, the second processing packet comprising a second destination identifier,
wherein the first router is configured to perform operations comprising:
receiving, at an internal ingress port of the first router, the first processing packet,
obtaining a first source identifier from the secured register,
determining that the first source identifier and the first destination identifier are a first authorized communication pair,
routing, after determining that the first source identifier and the first destination identifier are the first authorized communication pair, the first processing packet to a first egress port of the first router based on the first destination identifier,
receiving, at an external ingress port of the first router, the transport packet from the second chip,
determining that the second source identifier and the second destination identifier are a second authorized communication pair; and
routing, after determining that the second source identifier and the second destination identifier are the second authorized communication pair, the second processing packet to a second egress port of the first router based on the second destination identifier.

11. The system of claim 10, comprising:
a third chip, wherein the first router is configured to determine that the first processing packet is to be routed to the third chip via the first egress port; and
a first controller coupled with the first egress port, wherein the first controller is configured to generate an outgoing transport packet that comprises an outgoing transport header and the first processing packet, wherein the first controller is configured to insert the first source identifier into the outgoing transport header, and wherein the first controller is configured to cause a transmission of the outgoing transport packet to the third chip.

12. The system of claim 11, wherein the outgoing transport header is an outgoing medium access control (MAC) header, wherein the outgoing MAC header comprises a MAC source address, and wherein the MAC source address is separate from the first source identifier included in the outgoing transport header.

13. The system of claim 10, comprising:
a third chip, wherein the first router is configured to determine that the second processing packet is to be routed to the third chip via the second egress port; and
a second controller coupled with the second egress port, wherein the second controller is configured to generate an outgoing transport packet that comprises an outgoing transport header and the second processing packet, wherein the second controller is configured to insert the second source identifier into the outgoing transport header, and wherein the second controller is configured to cause a transmission of the outgoing transport packet to the third chip.

14. The system of claim 10, wherein the first router is configured to perform operations comprising determining that the internal ingress port is a valid port of arrival for the first source identifier, and wherein routing the first processing packet is conditioned on the determination that the internal ingress port is the valid port of arrival for the first source identifier and the determination that the first source identifier and the first destination identifier are the first authorized communication pair.

15. The system of claim 10, wherein the first router is configured to perform operations comprising determining that the external ingress port is a valid port of arrival for the second source identifier, and wherein routing the second processing packet is conditioned on the determination that the external ingress port is the valid port of arrival for the second source identifier and the determination that the second source identifier and the second destination identifier are the second authorized communication pair.

16. The system of claim 10, wherein the first source identifier comprises a first chip number assigned to the first chip, and wherein the second source identifier comprises a second chip number assigned to the second chip.

17. The system of claim 10, wherein the first router is configured to perform operations comprising determining a destination application domain identifier associated with the second destination identifier,
wherein the second source identifier comprises a source application domain identifier, and
wherein determining that the second source identifier and the second destination identifier are the second authorized communication pair comprises determining that the source application domain identifier matches the destination application domain identifier.

18. The system of claim 10, wherein the first source identifier comprises a cluster identifier that identifies a source cluster of the first chip, the source cluster comprising the computing resource, and wherein determining that the first source identifier and the first destination identifier are the first authorized communication pair comprises using the cluster identifier.

19. The system of claim 10, wherein the second source identifier comprises a cluster identifier that identifies a source cluster of one or more computing resources on the second chip, and wherein determining that the second source identifier and the second destination identifier are the second authorized communication pair comprises using the cluster identifier.

20. A system comprising:
a first chip comprising a first router, a plurality of first computing resources, and a first secured register to store a first source identifier, the first source identifier representing a chip number assigned to the first chip, wherein a first computing resource of the plurality of first computing resources is configured to generate a first processing packet, and the first processing packet comprising a first destination identifier; and
a second chip coupled with the first chip, the second chip comprising a plurality of second computing resources, and a second secured register to store a second source identifier, the second source identifier representing a chip number assigned to the second chip, wherein a second computing resource of the plurality of second computing resources is configured to generate a second processing packet, and the second processing packet comprising a second destination identifier, and wherein the second chip is configured to transmit a transport packet to the first chip, the transport packet comprising the second source identifier and the second processing packet,
wherein the first router is configured to receive, at an internal ingress port of the first router, the first processing packet, obtain the first source identifier from the secured register, determine that the first source identifier and the first destination identifier are associated with a same first application domain, and route, after a determination that the first source identifier and the first destination identifier are associated with the same first application domain, the first processing packet to a first egress port of the first router based on the first destination identifier, and
wherein the first router is configured to receive, at an external ingress port of the first router, the transport packet from the second chip, determine that the second source identifier and the second destination identifier are associated with a same second application domain, and route, after a determination that the second source identifier and the second destination identifier are associated with the same second application domain, the second processing packet to a second egress port of the first router based on the second destination identifier.

21. The system of claim 20, comprising:
a third chip, wherein the first router is configured to determine that the first processing packet is to be routed to the third chip via the first egress port; and
a first controller coupled with the first egress port, wherein the first controller is configured to generate an outgoing transport packet that comprises an outgoing transport header and the first processing packet, wherein the first controller is configured to insert the first source identifier into the outgoing transport header, and wherein the first controller is configured to cause a transmission of the outgoing transport packet to the third chip.
